(19) United States
(12) Patent Application Publication
(10) Pub. No.: US 2004/0267898 A1
(43) Pub. Date: Dec. 30, 2004

(54) Status information for software used to perform a service

(76) Inventor: Nicholas David Parkyn, Oakville (CA)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/607,213

(22) Filed: Jun. 25, 2003

(51) Int. Cl. G06F 15/16

(52) U.S. Cl. 709/217

(57) ABSTRACT

Methods and systems of service discovery and use are described. An application software component is for performing a service. A source of an application software component is contacted. Information descriptive of the status of the application software component is received. The status of the application software component is provided in response to a request for the service.

### TECHNICAL FIELD

Embodiments of the present invention relate to methods and systems for providing services such as process-based, software-based or Web-based services that are invoked locally (same system or local area network [LAN]) or remotely (wide area network [WAN] or Internet [Web]). More specifically, embodiments of the present invention relate to methods and systems for the discovery and use of such services.

### BACKGROUND ART

Operational support systems (OSS) and business support systems (BSS) enable service providers and telecommunications companies to provide businesses and the like with access to software, perhaps of a specialized nature, that businesses find useful. In general, a provider of such a service hosts and manages application software or application software components that perform a particular function or functions. The software is exposed across the Internet so that it can be called and used by remote business processes. The OSS and BSS systems themselves are based on application software components that perform a particular function or functions that are provided locally within a local computing system, a LAN, or a WAN. Processes are used to aggregate services in an orchestrated way using business logic; however, processes themselves can be services. These processes include business-related processes that enable business functionality and utilize underlying infrastructure services to provide the lower levels of functionality down to and including the network layer. Interaction between services can be point-to-point or point-to-multipoint using integrated service management, integrated message-oriented middleware, the Internet, a WAN or LAN (e.g., Web services using HyperText Transfer Protocol), lower level transport protocols, or a combination of these.

In a service-based environment, it is fundamentally important to understand the functionality that a service provides and how to interact with the service. That is, it is important to facilitate:

service discovery (finding services, or services that are available);

service functionality (the functionality and expected behavior of the service); and

service location (how to connect to, or bind with, the service).

Accordingly, descriptions of the functionality and location (e.g., functionality and bind information) of a service are stored in a defined repository in a standardized form (often referred to as a contract). Examples of this are UDDI (Universal Description, Discovery and Integration) contracts and TMF NGOSS (TeleManagement Forum Next Generation Operations System Support) contracts.

In essence, a contract describes the type of service provided by an application software component and what information is needed to invoke that service. The bind information provided by the contract includes, for example, a Uniform Resource Locator (URL) for the application software component. Other information, such as commercial terms, parameters for invoking the software, limitations on those parameters, and the like, can also be provided by the contract.

A problem can occur when a service process, executing locally or remotely, attempts to use another service and the software, script or process providing that service is not available, perhaps due to maintenance or lack of connectivity. If a service attempts to use another service which is not available, the interaction will fail to complete or timeout. This can result in unexpected delays, unacceptable or unexpected behavior that may be unacceptable, especially when completion of a higher level task, activity, service or process which depends on the outcome of this interaction is subject to a service level agreement that might impose financial penalties when performance goals are not met.

Also, starting a process, script or higher-level service but not being able to complete it can unnecessarily consume available computational resources, not only during the partial execution, but also while the process, script or higher-level service is idled waiting for a response. For example, a process that is started but not completed can still consume processor resources while idling. There may be many processes running in parallel, and as more and more of the processes are idled, more and more resources are used, perhaps degrading performance for those processes that are still running.

Accordingly, a method and/or system that can avoid the problems described above would be of value. Embodiments of the present invention provide this and other advantages.

### DISCLOSURE OF THE INVENTION

Embodiments of the present invention pertain to methods and systems of service discovery and use. In one embodiment, a source of an application software component (e.g., software, process or scripting) is contacted. The application software component is for performing a service. Information descriptive of the status of the application software component is received. The status of the application software component is provided in response to a request for the service.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a diagram showing the flow of information between blocks in a service discovery architecture according to one embodiment of the present invention.

FIG. 2 is a diagram showing the flow of information between blocks in a service discovery architecture according to another embodiment of the present invention.

FIG. 3 is a flowchart of a method for service discovery according to one embodiment of the present invention.

FIG. 4 is a flowchart of a method for performing a process according to one embodiment of the present invention.

FIG. 5 is a flowchart of a method for performing a process using a process or service launcher according to one embodiment of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

Aspects of the present invention may be practiced on a computer system that includes, in general, a processor for processing information and instructions, random access (volatile) memory (RAM) for storing information and instructions, read-only (non-volatile) memory (ROM) for storing static information and instructions, a data storage device such as a magnetic or optical disk and disk drive for storing information and instructions, an optional user output device such as a display device (e.g., a monitor) for displaying information to the computer user, an optional user input device including alphanumeric and function keys (e.g., a keyboard) for communicating information and command selections to the processor, and an optional user input device such as a cursor control device (e.g., a mouse) for communicating user input information and command selections to the processor.

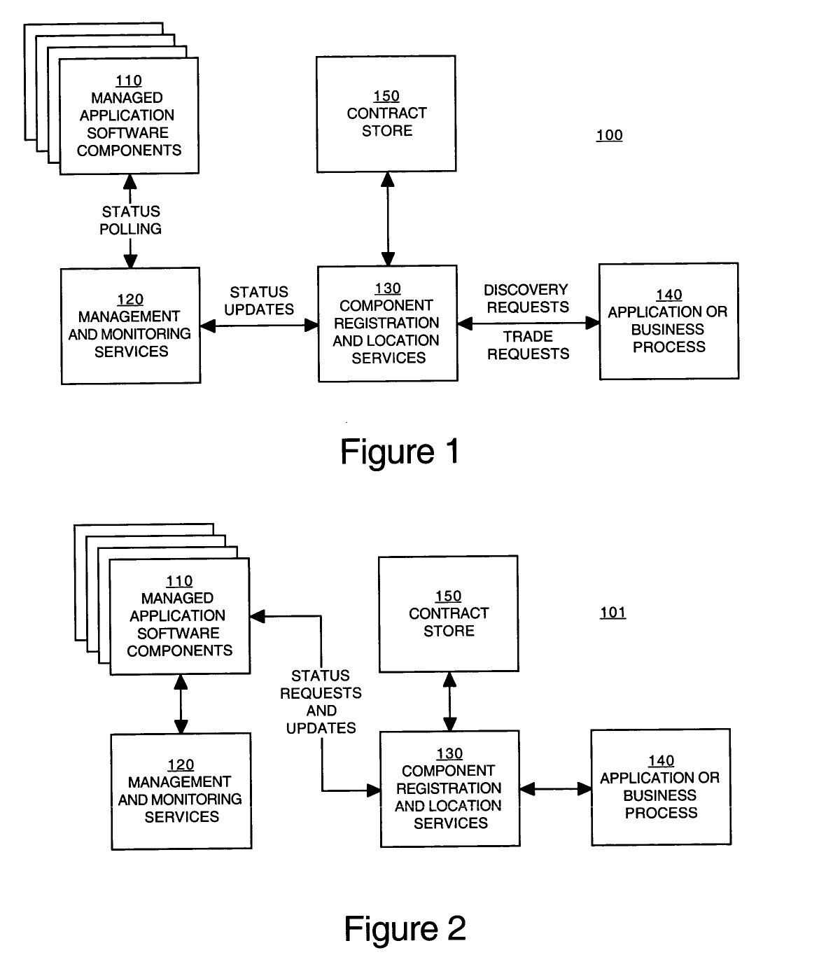

FIG. 1 is a diagram showing the flow of information between blocks in a service discovery architecture 100 according to one embodiment of the present invention. The various blocks of service discovery architecture 100 can reside on the same or on different devices in a network of devices that can communicate with each other. These types of devices can include but are not limited to computer systems and storage devices.

The functionality of each of these blocks is described below. A single device can provide multiple functionality. For example, management and monitoring services 120 and component registration and location services 130 can be provided by the same device. Also, functionality can be distributed among multiple devices. For example, one managed application software component can be stored on one device and another managed application software component can be stored on a different device, or contract store 150 can be co-located with managed application software components 110, management and monitoring services 120, or component registration and location services 130.

Application or business process or other services 140 (hereinafter, “application or business process 140”) aggregates services in an orchestrated way using business logic. It is appreciated that there may be a hierarchy of services. In other words, one service (provided by an application software component or components) may invoke another service (provided by another application software component or components). A service can be a combination of other services. Application or business process 140 can itself be a service used in another application or business process. Hence, application or business process 140 can refer to an application or business process as well as to other services.

Managed application software components 110 include application software components that can be called and used by application or business process 140. Each of these application software components, or a combination of these components, can be said to provide a service or services. A service can be provided by software, process or scripting. Hence, as used herein, “application software component” refers to software, process or scripting.

A particular service can be provided by different (e.g., competing) application software components. That is, an application or business process usually can choose among different application software components that provide or perform the same service.

In one embodiment, an application or business process 140 is implemented on a local device (e.g., a client or user device). In one such embodiment, the other elements of service discovery architecture 100 are accessed locally, or over the Internet, a wide area network (WAN), a local area network (LAN) or the like, point-to-point or point-to-multipoint, using integrated service management, integrated message-oriented middleware, the Internet, a WAN or LAN (e.g., Web services using HyperText Transfer Protocol), lower level transport protocols, or a combination of these. The other elements of service discovery architecture 100 are for locating and providing services, such as software services, that are utilized by application or business process 140.

Contract store 150 includes contracts that describe the functionality and location (e.g., bind information) of each of the managed application software components 110. It is appreciated that contracts can be stored in different repositories rather than in a single contract store as shown by FIG. 1.

In essence, a contract describes the type of service provided by an application software component and what information is needed to invoke that service. The bind information provided by the contract includes, for example, a Uniform Resource Locator (URL) for the application software component. Other information, such as commercial terms, parameters for invoking the software, limitations on those parameters, and the like, can also be provided by the contract. Significantly, according to embodiments of the present invention, a contract includes information describing the status of an associated application software component. The contract can also include information that describes the different types of statuses that might be returned in response to a service discovery request or a trade request, and how the different types of statuses should be interpreted.

There can be multiple instances of a service. One contract can be used to represent all such instances, or multiple separate contracts can be used instead, each contract representing a single instance of a service or some subset of the multiple service instances. A status can be provided for each service instance associated with a contract, or a status can be provided for each separate contract.

Each of the managed application software components 110 is registered with component registration and location services 130. More specifically, the contracts associated with each of the application software components 110 are registered with component registration and location services 130. Component registration and location services 130 receives service discovery requests from an application or business process 140, and matches a request to an application software component or components that can provide the service. Trade requests can then be exchanged between application or business process 140 and the application software component(s) that were matched to the service discovery request. At some point, one of the application software components, or a set of such components, is selected to perform or provide the service. The selection can be made by a human user or automatically by application or business process 140.

Significantly, according to the embodiments of the present invention, the statuses of the various application software components of interest are provided to application or business process 140, or to a human user that is setting up that process, in response to a service discovery request or to a trade request. In the present embodiment, component registration and location services 130 provides the status information to application or business process 140, or to a human user that is setting up that process. Component registration and location services 130 can also update status information in contract store 150. For example, a contract can include a status indicator or status information for an associated application software component, and this status indicator/information can be maintained up-to-date by component registration and location services 130 based on the information provided by management and monitoring services 120.

In one embodiment, management and monitoring services 120 polls the managed application software components 110 to determine their respective statuses. A polling request can be in the form of a mock request for an application software component. In one such embodiment, the polling occurs continuously. In another such embodiment, the polling occurs according to a predetermined schedule. In the latter embodiment, the intervals between polling requests can be constant or variable.

In yet another embodiment, in lieu of a polling request, each of the application software components 110 automatically provide their respective statuses to management and monitoring services 120, either continuously or at various times. In one more embodiment, the status of an application software component is provided to management and monitoring services 120 when there is a change in status of that application software component.

FIG. 2 is a diagram showing the flow of information between blocks in a service discovery architecture 101 according to another embodiment of the present invention. The various elements of service discovery architecture 101 are as described above in conjunction with FIG. 1. In the embodiment of FIG. 2, component registration and location services 130 polls the application software components 110 (or a specific subset thereof) specifically in response to a discovery request or a trade request. The status information is then forwarded to the initiator of the discovery or trade request (e.g., to application or business process 140).

In the various embodiments just described, status information is collected prior to execution of the application or business process 140. In one embodiment, in addition to or in lieu of the above, status information is collected after the application or business process 140 begins execution.

In addition to status information, availability information and/or performance information can also be provided. Availability information reflects the historical record of the relative amount of time that an application software component is available over time. For example, availability information can include the percentage of time that an application software component has actually been available. Status information provides an indication of the current state of an application software component and thus identifies whether a component is currently available, while availability information indicates the probability that the component will be available when needed.

Performance information provides an indication of, for example, how fast a particular application software component can execute, or the computational resources required by a particular application software component. Performance information can provide a measure of a particular application software component's current state of performance versus its optimum state of performance, and as such can provide an indication of possible degraded performance. Also, as noted above, there can be multiple application software components that provide the same service. Performance information can thus provide one mechanism for differentiating between the various application software components.

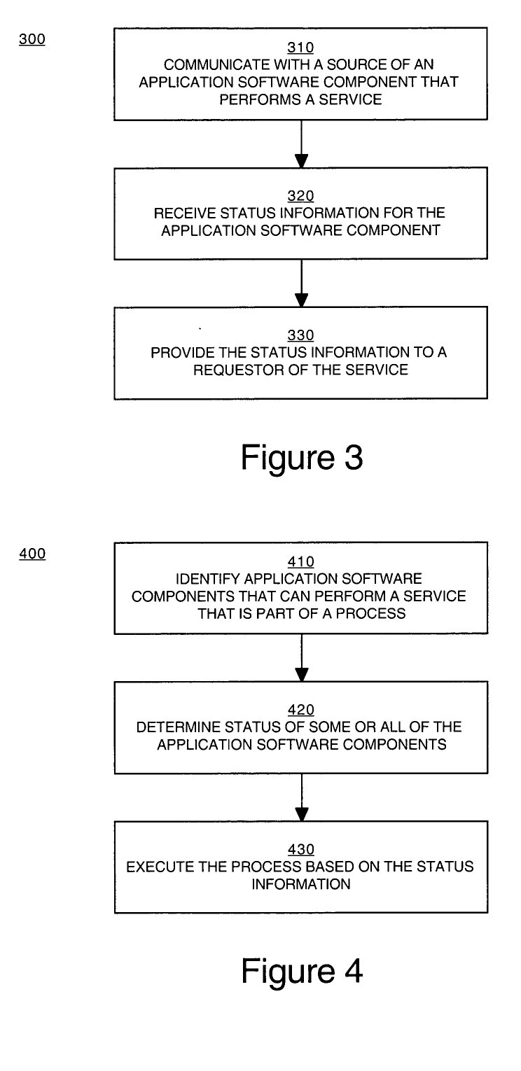

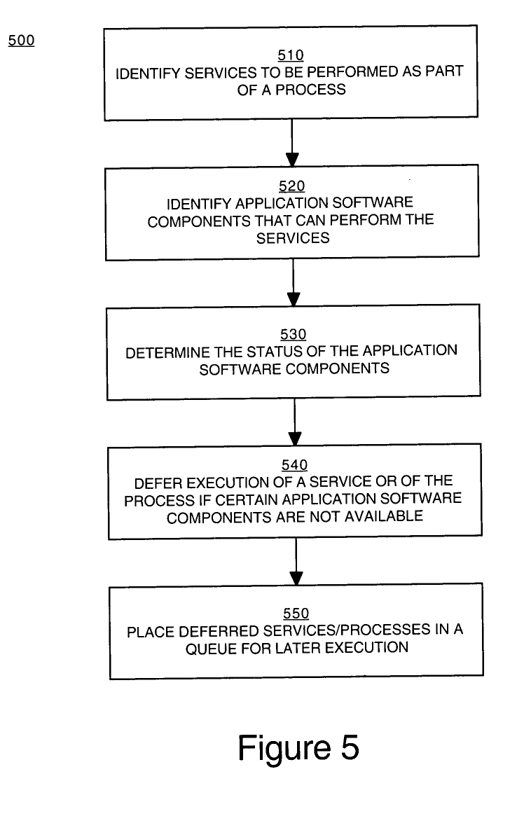

FIGS. 3, 4 and 5 describe the embodiments of FIGS. 1 and 2 in practice. FIG. 3 is a flowchart of a method for service discovery according to one embodiment of the present invention. FIG. 4 is a flowchart of a method for performing a process according to one embodiment of the present invention. FIG. 5 is a flowchart of a method for performing a process using a process or service launcher according to one embodiment of the present invention.

Although specific steps are disclosed in flowcharts 300, 400 and 500, such steps are exemplary. That is, embodiments of the present invention are well suited to performing various other steps or variations of the steps recited in those flowcharts. It is appreciated that the steps in the flowcharts may be performed in an order different than presented, and that not all of the steps in the flowcharts may be performed. All of, or a portion of, the methods described by flowcharts 300, 400 and 500 can be implemented using computer-readable and computer-executable instructions which reside, for example, in computer-usable media of a computer system or like device.

Referring first to FIG. 3, flowchart 300 is typically implemented by either management and monitoring services 120 or component registration and location services 130 of FIGS. 1 and 2, or a combination thereof. Flowchart 300 is described for singular instances of application software components, services and processes; however, the description can be readily extended to multiple instances of each.

In step 310 of FIG. 3, communication occurs with a source of an application software component that provides (performs) a service.

In step 320, status information for the application software component is received. In one embodiment, availability information is also received. In another embodiment, performance information is also received.

Steps 310 and 320 can be performed proactively (before a discovery or trade request for the application software component or the service it performs is received from an application or business process) or reactively (in response to a discovery or trade request). In one embodiment, communication with the source takes the form of a polling or demand request for status information. The polling request is initiated by, for example, management and monitoring services 120 or component registration and location services 130. The polling request can be issued continuously or at various time intervals. In another embodiment, status information is provided by the application software component even in the absence of a polling request. The status information can be provided by the application software component either continuously or at various time intervals, or it can be provided when there is a change in status of the application software component.

In step 330, the status information is provided to an application or business process that is requesting the service or the application software component. For example, application or business process 140 (FIG. 1) requests a particular service that is matched to a particular application software component (as mentioned above, multiple application software components may be matched to the requested service). In one embodiment, in response to the request from application or business process 140, the status of the particular application software component is determined. Alternatively, in another embodiment, the status information is already determined ahead of the request from application or business process 140, as described above. In either case, the status information is returned to application or business process 140.

The current status of a service or of an application software component that provides the service is thus known to the application or business process (or to the person setting up that process) before the process is set up, or before the process is executed. In addition, as mentioned above, the status of a service or application software component can be determined while the process is executing. For example, execution of a process can begin, and the status of a service or application software component can be determined as required. It is appreciated that a combination of these scenarios can also be implemented. That is to say, status(es) can be determined before a process is executed or as the process is being set up, and later as the process is executed.

Accordingly, proactive behavior and contingency planning become possible. A process does not have to be established without knowing whether certain services or application software components will be available. As a result, a decision can be made to use another service or application software component in place of one that is unavailable. This decision can be made up front, or after the process is started. Alternatively, a decision can be made to not begin execution of the process until the status information indicates that all of the services and application software components used by the process are available.

Furthermore, “secondary” (backup) services and application software components can be identified and incorporated into the process. The secondary services and software components can be used should the “primary” service or software component be unavailable. The process can thereby have a dynamic nature as it executes. In other words, at each point in the process in which there is a transition to a different service or application software component, the process can use the status information to select an available service or application software component and continue executing, without having to defer execution should the primary service or application software component be available. Note that this can be accomplished without human intervention. Moreover, the process can be forward looking, selecting an execution path based on the availability of downstream services and application software components. That is, at a point in the process in which there is a transition to a different service or application software component, a decision can be made based not only on the status information of the immediate service or application software component, but also considering the status information of the other service and application software components that depend or flow from the immediate one.

As can be inferred from the above discussion, when a process is set up, it can incorporate contingencies and recovery mechanisms based on the status information, increasing the likelihood that the process can continue to execute with a reduced amount of delay, or without delay at all. By eliminating or reducing the instances in which the process is begun and then idled, computational resources are saved.

Referring now to FIG. 4, a method for performing a process according to one embodiment of the present invention is described using flowchart 400. Flowchart 400 is typically implemented by an application or business process executing on a computer system, with or without human intervention.

In step 410, application software components that provide the services included in the process are identified. As mentioned, this can be accomplished using service discovery and/or trade requests that match an application software component or components to a service.

In step 420, status information for the application software components is determined. In the present embodiment, the status information is determined in response to the discovery or trade requests. The status information is received from, for example, component registration and location services 130 of FIGS. 1 and 2 which in turn has either determined status in advance of the discovery and trade requests or in response to those requests. The status information can be determined before the process begins execution and/or while the process is executing.

In step 430 of FIG. 4, the process is executed considering the status information. For example, one of the application software components identified in step 410 can be selected. If the status information indicates that the selected application software component is not available, then an alternative application software component can be selected. Alternatively, a different service, using a different application software component, can be performed instead. As another alternative, the service can be deferred until the selected application software component becomes available.

Other contingency actions can be performed as previously described herein. For example, execution of a process can be viewed as proceeding along different paths, depending on the availability of application software components at points along the paths. In other words, as discussed above, execution of a process can branch to one application software component or to another, depending on whether or not the “primary” application software component is available. Each execution path can be considered as including a set of application software components. One execution path can be selected over another by determining the statuses of the various application software components used along each path.

Referring next to FIG. 5, a method for performing a process using a process or service launcher according to one embodiment of the present invention is described by flowchart 500. Flowchart 500 is typically implemented by an application or business process executing on a computer system, with or without human intervention.

In step 510, the services to be performed as part of a process are identified. In step 520, application software components that can perform the services are identified. In step 530, the statuses of the application software components are determined.

In step 540, execution of a service, or of the process itself is deferred if the status information indicates that an application software component used by the service or in the process is not available. In other words, the process or service is shut down instead of idled. As such, computational resources are not being consumed by the service/process.

In step 550, services or processes deferred in step 540 are placed in a queue for later execution. The queue functions analogously to a process or service launcher. Status information can be evaluated before execution of the service or process is re-initiated.

In summary, embodiments of the present invention provide methods and systems that can identify at an early point whether or not services (provided by application software components) are available for use in an application or business process. As such, it is possible to identify and implement contingency plans, and to make intelligent decisions with regard to how to set up the process as well as when to execute the process. In essence, decisions can be made about an application software component without having to commit to use of that application software component.

Embodiments of the present invention are thus described. While the present invention has been described in particular embodiments, it should be appreciated that the present invention should not be construed as limited by such embodiments, but rather construed according to the following claims.

What is claimed is:

1. A method of service discovery, said method comprising:
communicating with a source of an application software component, said application software component for performing a service;
receiving information descriptive of a status of said application software component; and
providing said status in response to a request for said service.

2. The method of claim 1 further comprising:
issuing to said source a request for said status.

3. The method of claim 2 wherein said request for said status is issued automatically at different times.

4. The method of claim 2 wherein said request for said status is issued automatically in response to said request for said service.

5. The method of claim 1 further comprising:
receiving said status automatically at different times.

6. The method of claim 1 further comprising:
receiving said status automatically in response to a change in status of said application software component.

7. The method of claim 1 further comprising:
matching said application software component with said request for said service, wherein said application software component is selectable from a plurality of application software components that provide said service.

8. The method of claim 1 wherein said application software component can be utilized in a process, wherein said status is checked as said process is set up such that decisions on setting up said process can be made based on service availability.

9. The method of claim 1 wherein said application software component is utilized in a process, wherein said status is checked as said process is executed such that decisions on executing said process can be made based on service availability.

10. The method of claim 1 wherein availability information for said application software component is also provided.

11. The method of claim 1 wherein performance information for said application software component is also provided.

12. A method of performing a process that utilizes an application software component, said method comprising:
identifying a plurality of application software components, each of said application software components having the capability to perform a particular service that is a part of said process;
determining a status of at least a portion of said application software components; and
executing said process according to said status such that decisions on executing said process can be made based on service availability.

13. The method of claim 12 wherein said application software components are stored in one or more repositories accessible by said process via the Internet.

14. The method of claim 12 wherein said status is determined prior to said executing.

15. The method of claim 12 wherein said status is determined as said process is executed.

16. The method of claim 12 wherein said executing comprises:
selecting from said plurality of application software components a first application software component to perform said service; and
taking an alternative course of action when said status indicates that said first application software component is not available.

17. The method of claim 16 wherein said alternative course of action comprises:
selecting a second application software component to perform said service.

18. The method of claim 16 wherein said alternative course of action comprises:
performing a different service in said process, said different service utilizing an application software component different from said first application software component.

19. The method of claim 16 wherein said alternative course of action comprises:
deferring said service until a time when said status indicates that said first application software component is available.

20. The method of claim 16 wherein said first application software component is also selected according to its historical availability.

21. The method of claim 16 wherein said first application software component is also selected according to its predicted performance.

22. The method of claim 12 wherein said process comprises a first execution path and a second execution path, wherein said first execution path uses a first set of application software components and said second execution path uses a second set of application software components, wherein said executing comprises:
selecting an execution path according to respective statuses of said first set and said second set of application software components.

23. A method of performing a process that utilizes an application software component, said method comprising:
identifying services to be provided as part of said process;
identifying application software components that are for performing said services;
determining statuses of said application software components;
deferring execution of a service in said process if application software components for performing said service are unavailable; and
queuing deferred services for subsequent execution.

24. The method of claim 23 wherein said application software components are stored in one or more repositories accessible by said process via the Internet.

25. The method of claim 23 wherein said statuses are determined prior to execution of said service, wherein execution of said service is not begun until said application software components are available.

26. The method of claim 23 wherein execution of said process is deferred if execution of a service in said process is deferred.

27. The method of claim 23 wherein said statuses are determined as said process is executed, wherein further execution of said process is deferred.

28. The method of claim 23 wherein said process comprises multiple execution paths, said execution paths using different combinations of application software components, wherein said deferring comprises:
deferring execution of an execution path until said statuses indicate that application software components used by said execution path are available while executing those execution paths that use application software components that are indicated as being available.
